(19) United States
(12) Patent Application Publication
(10) Pub. No.: US 2025/0036460 A1
(43) Pub. Date: Jan. 30, 2025

(54) SCHEDULER FOR A PROCESSING DEVICE INCORPORATING EXTERNAL FACTORS

(71) Applicant: Kyocera Document Solutions Inc., Osaka (JP)

(72) Inventor: Charles HENZE, Pleasanton, CA (US)

(73) Assignee: Kyocera Document Solutions Inc., Osaka (JP)

(21) Appl. No.: 18/226,398

(22) Filed: Jul. 26, 2023

(51) Int. Cl. G06F 9/48

(52) U.S. Cl. CPC G06F 9/4881

(57) ABSTRACT

A processing device within a computing system uses a scheduler that dynamically processes jobs. Jobs are received at the processing device. The scheduler uses one or more scheduling algorithms to schedule the jobs for processing. The processing device queries one or more external systems for factors related to parameters and attributes at the external systems. Factors may include quality of service, capacity, load, time of day, and operations currently running on the external system. The scheduler uses the factors from the external system to modify the schedule for the received jobs.

### FIELD OF THE INVENTION

The present invention relates to a computing system having a processing device that schedules jobs to be completed according to various factors. More particularly, the present invention relates to computing system having a scheduler that takes into account external factors with scheduling job processing.

### DESCRIPTION OF THE RELATED ART

Schedulers for processing devices, such as computers or printing devices, use properties of the input tasks to determine an order and rate of processing for jobs. For example, a scheduler may take into account factors about the received job to schedule it for processing. These factors for the received job may not be enough information to properly schedule completion of the jobs.

### SUMMARY OF THE INVENTION

A method for managing a workflow of a computing system is disclosed. The method includes receiving a job at a processing device within the computer system. The method also includes placing the job in a scheduler at the processing device. The method also includes scheduling the job to be processed according to a schedule determined by a scheduling process. The method also includes querying an external system for a factor related to the external system. The method also includes modifying the scheduling process of the scheduler with the factor. The job is rescheduled within the schedule. The method also includes processing the job at the processing device according to the schedule.

A method for managing jobs within a computing system is disclosed. The method includes receiving a plurality of jobs in a scheduler at the processing device. The method also includes scheduling the plurality of jobs to be processed according to a schedule determined by a scheduling process. The first job is scheduled to be processed prior to the second job. The method also includes querying an external system for a factor related to the external system. The method also includes modifying the scheduling process of the scheduler with the factor. The first job is rescheduled with the schedule to be processed after the second job. The method also includes processing the first job and the second job at the processing device according to the schedule.

A computing system is disclosed. The computing system is configured to receive a job at a processing device within the computer system. The computing system also is configured to place the job in a scheduler at the processing device. The computing system also is configured to schedule the job to be processed according to a schedule determined by a scheduling process. The computing system also is configured to query an external system for a factor related to the external system. The computing system also is configured to modify the scheduling process of the scheduler with the factor. The job is rescheduled within the schedule. The computing system also is configured to process the job at the processing device according to the schedule.

### BRIEF DESCRIPTION OF THE DRAWINGS

Various other features and attendant advantages of the present invention will be more fully appreciated when considered in conjunction with the accompanying drawings.

FIG. 1A illustrates a computing system according to the disclosed embodiments.

FIG. 1B illustrates a digital front end (DFE) for a processing device within the computing system according to the disclosed embodiments.

FIG. 2 illustrates a block diagram of components of the printing device for use within the computing system according to the disclosed embodiments.

FIG. 3 illustrates a block diagram of a scheduler using a first factor from a first external system to modify a schedule for the processing device according to the disclosed embodiments.

FIG. 4 illustrates a flowchart for managing workflow in a computing system having a process device according to the disclosed embodiments.

FIG. 5 illustrates a flowchart for managing a plurality of jobs at the processing device according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

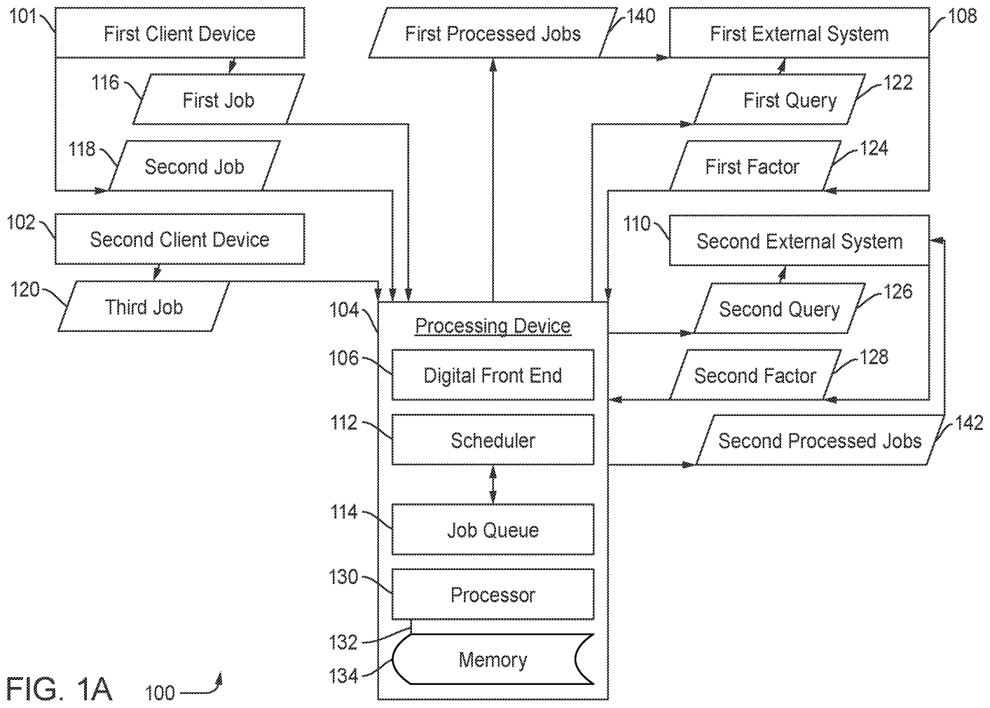

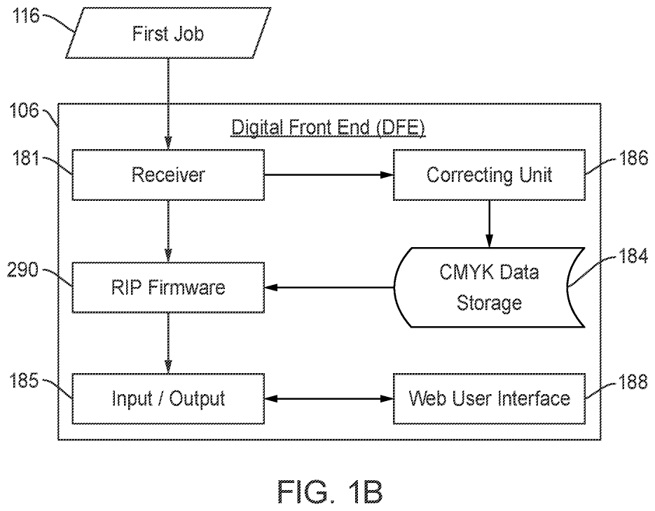

FIG. 1A depicts a block diagram of a computing system 100 for processing jobs according to the disclosed embodiments. Computing system may be a printing system or other system that processes “jobs” or tasks to be done by one or more processing devices 104. Processing device 104 may receive jobs from first client device 101 and second client device 102. Computing system 100 may include a plurality of client devices that send jobs to a plurality of processing devices.

Computing system 100 also may include destination systems that receive the results of the processed jobs from processing device 104. Thus, first external system 108 and second external system 110 are shown within computing system 100. External systems within computing system 100 may provide storage of documents or data processed by processing device 104. External systems also may provide further processing of the data provided by processing device 104. For example, first external system 108 may be a cloud storage system to store data and documents from processing device 104. Second external system 110 may be system to perform optical character recognition (OCR) processing on documents or data from processing device 104.

First client device 101 may send a plurality of jobs to processing device 104. For example, first client device 101 may send at least first job 116 and second job 118 to processing device 104. Jobs within computing system 100 may be documents, files, data, and the like that generated at a client device and sent to a processing device to be processed in some manner. For example, first job 116 and second job 118 may be print jobs provided to processing device 104, which may be a printing device. Alternatively, first job 116 and second job 118 may be data compiled at first client device 101 and sent to processing device 104 to be analyzed or modified in some manner.

Computing system 100 also includes second client device 102. Second client device 102 also may send a plurality of jobs to the processing device. Thus, second client device 102 sends third job 120. Computing system 100 may include any number of client devices that send jobs to processing device 104. In some embodiments, first client device 101 and second client device 102 may be computers or computing devices executing an application or program to generate jobs. In yet another example, jobs 116-120 may be online purchase orders and processing system 104 may be a platform to process the purchase orders for payment and fulfillment. First external system 108 and second external system 110 may be the online stores that take the orders from the jobs processed at processing device 104.

Processing device 104 includes components that enable processing of received jobs. Processing device 104 may include a processor 130 that executes instructions to perform operations. Processor 130 may configure processing device 104 to execute the operations. Processor 130 may be connected to a memory 134, which stores instructions to be executed by processor 130. Processor 130 and memory 134 may be connected by a bus 132, which allows data to flow between the two components.

Processing device 104 also includes a controller, or digital front end (DFE), 106. Controller 106 will, hereafter, be referred to as DFE 106. DFE 106 may include processor 130, bus 132, and memory 134. DFE 106 may control the components within processing device 104, especially if the processing device includes physical components. For example, if processing device 104 is a printing device, then DFE 106 may control the printing subsystem, scanning subsystem, and the like. A DFE 106 for a printing device is disclosed in greater detail by FIG. 1B, below.

As jobs are received by processing device 104, they must be scheduled for processing. Thus, scheduler 112 is provided to generate a schedule for processing jobs. Scheduler 112 may use a scheduling algorithm to arrange the jobs. A job queue 114 may be used to hold jobs until they are ready to be processed. Scheduler 112 uses the scheduling algorithm to schedule completion of the job. For example, the scheduling algorithm may be first in, first out (FIFO) such that the job received first is placed in the earliest position within job queue 114. Processing device 104 may receive first job 116, then second job 118, and then third job 120. Using a FIFO scheduling algorithm, scheduler 112 arranges the jobs within job queue 114 as first job 116, second job 118, and third job 120. Processing device 104 processes the jobs accordingly.

Other scheduling algorithms may be used. It may schedule the smallest file to be processed first. For example, first job 116 may be 5 MB, second job 118 may be 8 MB, and third job 120 may be 2 MB. Scheduler 112 would arrange the jobs in job queue 114 as third job 120, first job 116, and second job 118.

Another scheduling algorithm may use a priority designation in that each job includes metadata indicating a priority or “status” for the job. Using another example, second job 118 may have a priority of 1 while first job 116 and third job 120 have a lower priority, or 3. Thus, second job 118 may be placed first in job queue 114. Multiple scheduling algorithms may be used such that secondary algorithms are applied to the order of jobs. Using this example, first job 116 is received before third job 120. Thus, despite having the same priority level, first job 116 is placed ahead of third job 120 in job queue 114. It should be noted that using this scheduling algorithm, scheduler 112 may move second job 118 to the front of job queue 114 as it has a higher priority, even it is received after first job 116 and third job 120.

Scheduler 114, therefore, uses scheduling algorithms that use factors or parameters associated with the input, or jobs, to determine the schedule used by job queue 114 to process the jobs. While using the factors associated with the received jobs helps optimize the processing schedule, it does not take into account delays experienced externally that will impact how the processed job is received.

For example, first processed jobs 140 may be provided to first external system 108. Second processed jobs 142 may be provided to second external system 110. Each external system may have capacity or availability that impacts how or when the processed jobs are treated. For example, if the quality of service for first external system 108 is reduced, then first processed jobs 140 may not be handled in a timely manner. Delay may occur at first external system 108. In another example, second external system 110 may be performing backup operations and not addressing received data until the operations are complete. Thus, second processed jobs 142 need not be provided to second external system 110 until the backup operations are complete.

The disclosed embodiments seek to use this information about the external systems to optimize the scheduling algorithm for scheduler 112. Processing device 104 may send first query 122 to first external system 108. First query 122 may determine a feature of first external system 108 that can be used to modify the scheduling algorithm of schedule 112. These features are disclosed in greater detail below. First external system 108 may return first factor 124 to processing device 104 in response to first query 122. The same process may occur at second external system 110 using second query 126 and second factor 128.

First factor 124 of first external system 108 is received by processing device 104. Second factor 128 also may be received from second external system 110. Scheduler 112 uses first factor 124 to modify the scheduling algorithm and the schedule within job queue 114. For example, job queue 114 may have a schedule of first job 116, second job 118, and third job 120. Due to first factor 124, scheduler 112 may modify the scheduling algorithm to delay processing of jobs meant for first external system 108. If second job 118 is meant to be part of first processed jobs 140, then it may be moved to the back of job queue 114.

Scheduler 112 also may take into account second factor 128. Second factor 128 may indicate, for example, that second external system 110 is only available for users during certain times of the day so that jobs meant for this external system should be given priority during those times. Using the above example, third job 120 is to be processed and sent to second external system 110 as one of second processed jobs 142. Third job 120 may be moved to the front of job queue 114 by scheduler 112 using the modified scheduling algorithm during the specified times indicated by second factor 128.

In some embodiments, scheduler 112 and job queue 114 may be part of DFE 106. If processing device 104 is a printing device, then DFE 106 uses scheduler 112 and job queue 114 to process print jobs according to a schedule developed by the scheduling process using the scheduling algorithm. First factor 124 or second factor 128 may be used to modify the schedule accordingly. This way, the printing device is not printing or processing print jobs that will not be made available or processed by the applicable external system due to some issue. The disclosed embodiments optimize the processing of jobs using more information than just input data.

In other embodiments, computing system 100 may be a printing system such that processing device 104 is a DFE for the printing system. First external system 108 and second external system 110 may be printer components and copier components, respectively, within the printing system. Thus, if first external system 108 includes a print engine for the printing device, then first factor 124 may indicate the availability of the printer components. If the printer components are not available, such as during maintenance, then first external system 108 may return first factor 124 that tells scheduler 112 to delay print jobs and process other jobs within processing device 104 ahead of the print jobs.

In some embodiments, processing device 104 is really just scheduler 112. In other words, actual processing of jobs is done by the external systems. Processing device 104 just holds the jobs until they are released to the external systems for processing. Thus, jobs may not be “processed” at processing device 104. This term is used to refer to having the job forward to the appropriate external system for any processing. Thus, where the term “processing” is used with regard to processing device 104 and scheduler 112, the disclosed embodiments also encompass releasing the job within computing system 100 to be processed by the appropriate external system.

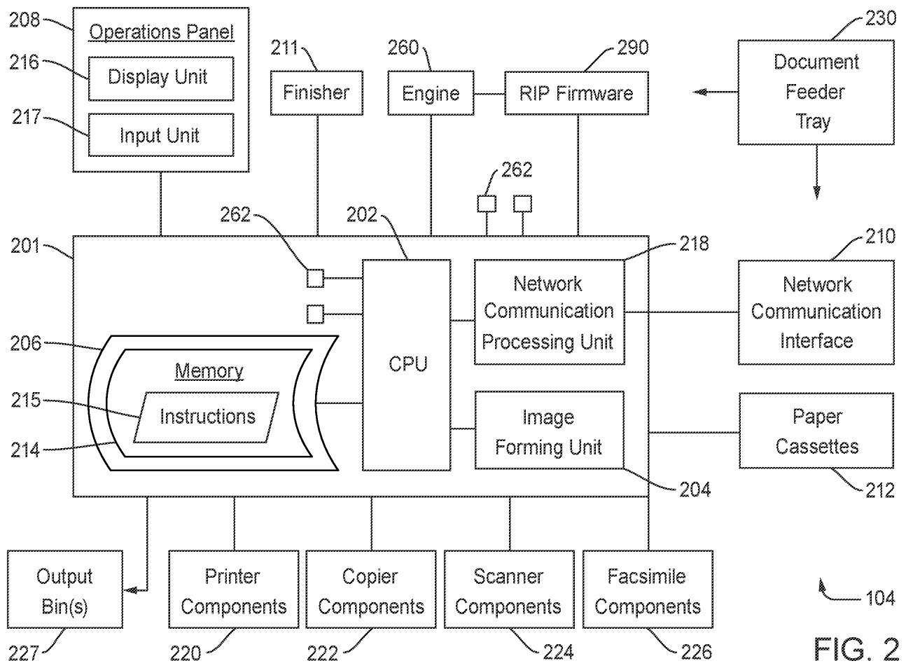

FIG. 1B depicts a block diagram of DFE 106 according to the disclosed embodiments. If processing device 104 is a printing device, then it will include DFE 106. DFE 106 includes a receiver 181, an RIP firmware 290, a CMYK data storage 184, an input/output connector 185, and a correcting unit 186. RIP firmware 290 also is disclosed in FIG. 2. Additional components within DFE 106 may be implemented, including those disclosed in FIG. 1A.

Within DFE 106, first job 116 may be a print job. Receiver 181 receives first job 116 received within system 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided by processing device, as a printing device, 104 alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 is transmitted within printing device 104 via input/output connector 185. The print condition information and the print medium type, as well as the rendering data, may be transmitted to engine 260 found in processing device 104 disclosed in FIG. 2.

DFE 106 also includes web user interface 188 that may communicate with other processing devices, first client device 101 or second client device 102, if it is located at a separate device, using, for example, input/output connector 185. Web user interface 188, or web application, allows a user of the DFEs of other printing devices to interact with content or software running on DFE 106.

FIG. 2 depicts a block diagram of components of processing device as a printing device, 104 according to the disclosed embodiments. The architecture shown in FIG. 2 may apply to any multi-functional printing device or image forming apparatus that performs various functions, such as printing, scanning, storing, copying, and the like within computing system 100. As disclosed above, processing device 104 may send and receive data from first client device 101, second client device 102, first external system 108, or second external system 110, if a separate device, and other devices within system 100.

Processing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Processing device 104, using computing platform 201, may be configured to perform various operations, such as scanning, copying, printing, receiving or sending a facsimile, or document processing. As such, processing device 104 may be a printing device or a multi-function peripheral including a scanner, and one or more functions of a copier, a facsimile device, and a printer. To provide these functions, processing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Processing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto processing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of processing device 104 to receive papers and documents to be processed. Feeder tray also may refer to one or more input trays for printing device 104. A document is placed on or in document processor input feeder tray 230, which moves the document to other components within processing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with processing device 104, such as any processors within components 220, 222, 224, or 226. Memory unit 206 also may store information for various programs and applications, as well as data specific to processing device 104. For example, a storage location 214 may include data for running an operating system executed by computing platform 201 to support the components within processing device 104. According to the disclosed embodiments, memory unit 206 may store the tokens and codes used in performing the deferral operations for processing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause processing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause processing device 104 to act as a printer, copier, scanner, and a facsimile device.

Processing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into processing device 104.

Processing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on processing device 104. CPU 202 also may retrieve information stored in memory unit 206, such as settings for processing device 104.

Processing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on processing device 104. RIP firmware 290 may be located in DFE 106, as disclosed above.

Processing device 104 may include one or more sensors 262 that collect data and information to provide to computing platform 201 or CPU 202. Each sensor 262 may be used to monitor certain operating conditions of processing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by processing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Processing device 104 communicates with other devices within system 100 via network communication interface 210 by utilizing a network protocol, such as the ones listed above. In some embodiments, processing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, processing device 104 submits and receives data from color management system 101 as well as other printing devices within computing system 100.

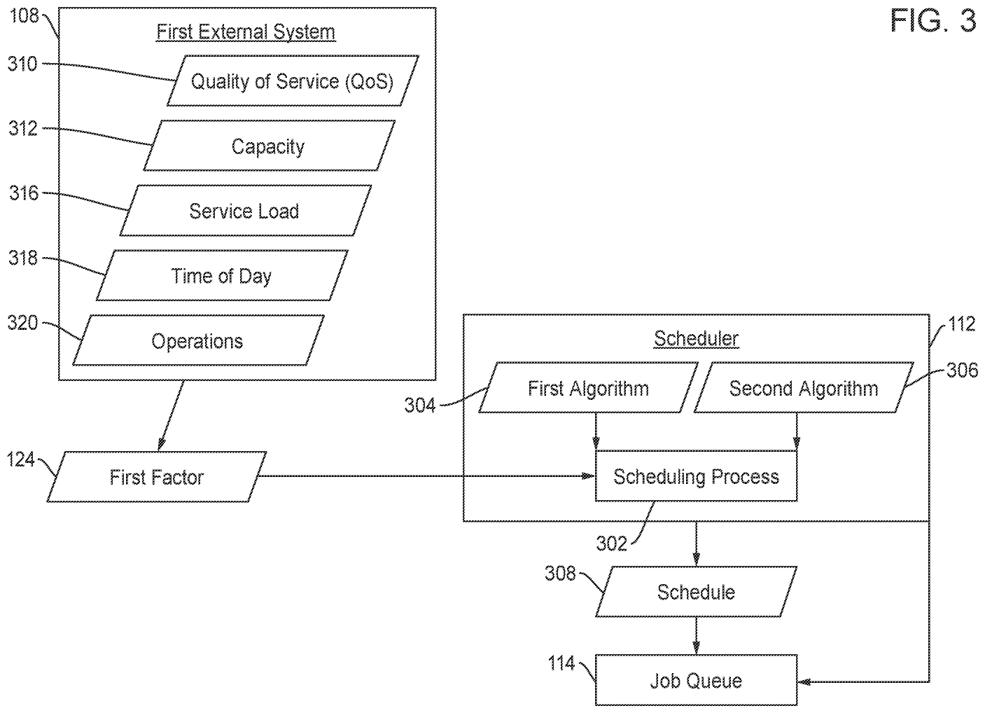

FIG. 3 depicts a block diagram of scheduler 112 using first factor 124 from first external system 108 to modify schedule 308 for processing device 104 according to the disclosed embodiments. As disclosed above, processing device 104 receives jobs from within computing system 100. Processing device 104 uses a schedule to order how the jobs are processed. For example, processing device 104 may use several processing algorithms to determine the order for the jobs within job queue 114.

The disclosed embodiments take into account one or more factors from external systems to modify the scheduling algorithms, which optimizes the processing within the processing device. For example, processing device 104 is not processing jobs or data for an external system that is not available. In other words, processed jobs will not be addressed at the external system based on the factor.

Scheduler 112 includes scheduling process 302. Scheduling process 302 uses one or more scheduling algorithms to generate schedule 308 for jobs within job queue 114. Thus, first scheduling algorithm 304 and second scheduling algorithm 306 may be used. The scheduling algorithms may use different schemes to generate the schedule for the print jobs. For example, first scheduling algorithm 304 may schedule jobs by priority designation. Thus, jobs having a higher priority are processed first at processing device 104. Second scheduling algorithm 306 may schedule jobs on a FIFO basis. Scheduler 112 may switch scheduling process 302 from first algorithm 304 to second algorithm 306 and vice versa. Further, scheduling process 302 may use first algorithm 304 as the initial scheduling algorithm then default to second algorithm 306 in the event of two or more jobs having the same priority.

As jobs are received at processing device 104, scheduler 112 determines schedule 308. Job queue 114 may use schedule 308 to arrange the jobs for processing. For example, using the above example algorithms, first job 116 and second job 118 are received at processing device 104 from first client device 101. Third job 120 is received from second client device 102. First job 116 may have the highest priority, or “1” according to computing system 100. Second job 118 may have a lower priority, or “2.” Third job 120 also may have a priority of 2. Second job 118 is received at processing device 104 before third job 120.

Processing device 104 requests scheduler 112 to generate a schedule 308 to arrange the received jobs within job queue 114. Scheduling process 302 first applies first algorithm 304 to place first job 116 at the front of the schedule. First job 116 may be placed ahead of other jobs in job queue 114 having a lower priority. In updating or generating schedule 308, scheduling process 302 places first job 116 at the front, unless there are other jobs having a priority of 1. If so, then second algorithm 306 may be used to place first job 116 after the previously received ones.

Second job 118 and third job 120 each have a priority of 2. Thus, first algorithm 304 is not applicable for scheduling process 302. Thus, second algorithm 306 may be applied using a FIFO algorithm. As noted above, second job 118 is received at processing device 104 before third job 120. Thus, scheduling process 302 will place second job 118 before third job 120 in schedule 308 for job queue 114. In other embodiments, additional scheduling algorithms may be used, such as file size in that jobs having a smaller file size may be processed first.

As can be appreciated, the factors or inputs for scheduling process 302 may come from the jobs themselves, such as priority levels, time of receipt, and file size. The disclosed embodiments also take into account factors from the external systems in scheduling jobs. Referring back to FIG. 1A, processing device 104 may send first query 122 to first external system 108 and second query 126 to second external system 110. These queries may ask for information from the external systems. In some embodiments, the queries may ask for the external system to respond back. These responses may be called factors. Thus, for example, first external system 108 returns first factor 124 back to processing device 104.

Factors may be based on some parameter or attribute of the external system that impacts how the processed jobs will be treated when provided to the external system. An example factor is quality of service (QoS) factor 310. In some embodiments, QoS factor 310 may refer to the amount of time for first external system 108 to respond to first query 122. For example, if the amount of time to respond exceeds a certain amount, then first external system 108 may be busy or at capacity for processing. In other embodiments, QoS factor 310 may refer to a ratio of how busy first external system 108 is in processing current tasks. For example, if current tasks, such as allowing user access to receive jobs, are taking too long, then the QoS 310 may be reduced.

Another factor may be capacity factor 312, which relates to whether first external system 108 is using above a certain amount of its processing capability. For example, if the processing capacity of first external system 108 is above 66%, then capacity factor 312 may reflect this by indicating that the first external system is near capacity. Processed jobs may not be handled in a timely manner to capacity being above the specified amount.

Service load factor 316 may refer to the current load on first external system 108. If the load on the external system is above certain amounts, then it should be noted to processing device 104. Time of day factor 318 may refer to the time of the day that first query 122 was received. Time of day may refer to the availability of first external system 108 during periods of time when external users and processes are likely to require the first external system. For example, during working hours, computing system 100 may designate that first external system 108 still process or provide services even if exceeding levels of capacity or loads. Services must be maintained during these hours. Alternatively, first external system 108 may not process data or provide services during off hours. Thus, there is no need to emphasize processing jobs during these hours.

Operations factor 320 may refer to operations that impact processing and services on first external system 108. For example, a backup operation may shutdown first external system 108 at various times so any incoming data or jobs will not be handled until the backup is complete. The same situation may be had for security checks, virus detection, and other operations that require first external system 108 to stop receiving incoming data or jobs for a period of time.

Other factors also may be used. First factor 124 may actually be a compilation of these factors to provide a processing order for first external system 108. Second external system 110 also may have these factors and compile them into second factor 128. First factor 124, preferably, should differ from second factor 128. Factors are received by scheduling process 302. The values from the factors modify scheduling process 302. For example, first factor 124 may indicate that QoS factor 310 shows that the quality of service is reduced at first external system 108. Other factors also may show that first external system 108 is very busy. Thus, jobs meant for first external system 108 may be moved within schedule 308 to be placed after other jobs meant for second external system 110.

In some instances, factors received from external systems may overrule scheduling algorithms being used by scheduling process 302. In other instances, the scheduling algorithms may be modified. For example, first algorithm 304 may still place higher priority jobs first in schedule 308 unless the destination external system is having some issue, such as reduced QoS, reduced capacity, or it is a time of day that the external system is not available.

According to the disclosed embodiments, processing device 104 may dynamically process incoming jobs to optimize how they are processed. Instead of just input parameters, such as file size, priority, or time of receipt, factors from external systems are used. This feature results in faster processing and better service as processing of jobs for one external system is not needlessly sacrificed for another external system not operating properly or shutdown.

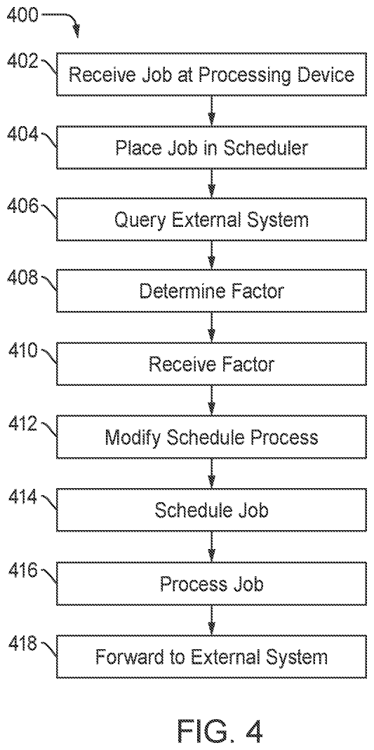

FIG. 4 depicts a flowchart 400 for managing workflow in a computing system 100 having a process device 104 according to the disclosed embodiments. Flowchart 400 may refer to FIGS. 1A-3 for illustrative purposes. Flowchart 400, however, is not limited to the embodiments disclosed by FIGS. 1A-3.

Step 402 executes by receiving first job 116 at processing device 104. Other jobs may be received at processing device 104 before, during, and after first job 116. Although processing device 104 receives jobs, it also forwards the processed jobs to external systems for additional tasks. In some embodiments, processing device 104 may be scheduler 112 in that no processing really occurs at the processing device.

In some embodiments, processing device 104 is a printing device such that first job 116 is a print job. Processing device 104 may include a DFE 106 having scheduler 112 that then schedules when jobs are provided to components within the printing device. Alternatively, processing device 104 may forward print jobs to external cloud storage systems, depending on metadata indicating a destination storage location. For example, processing device 104 may include a scanner that scans jobs.

Step 404 executes by placing first job 116 in scheduler 112. Scheduler 112 may determine schedule 308 for when jobs within job queue 114 are processed or released. First job 116 may be placed in job queue 114 according to schedule 308. Scheduler 112 uses a scheduling process 302 to determine schedule 308, using one or more scheduling algorithms, as disclosed above.

Step 406 executes by querying first external system 108 with first query 122 by processing device 104. In some embodiments, scheduler 112 may send first query 122. First query 122 is received by first external system 108. Step 408 executes by determining one or more factors relates to parameters and attributes about first external system 108. These factors are disclosed above. Factors may relate to the capacity and availability of first external system 108 to process and handle jobs. Thus, first external system 108 determines first factor 124. In some embodiments, processing device 104 may query the applicable external system for receipt of a job meant for that external system. In other embodiments, processing device 104 may periodically send queries to some or all of the external systems for updates.

Step 410 executes by receiving first factor 124 at scheduler 112. First factor 124 may be incorporated by scheduling process 302. Step 412 executes by modifying scheduling process 302 to dynamically process or generate schedule 308 with regarding to jobs meant for first external system 108. Thus, if first job 116 is meant for first external system 108, then the scheduling algorithm applicable to the job will be changed in response to first factor 124.

Step 414 executes by scheduling first job 116 using modified scheduling process 302. Schedule 308 is modified for first job 116. First job 116 may be placed in job queue 114 according to the schedule. Step 416 executes by processing first job 116, if applicable, at processing device 104 according to schedule 308. Step 418 executes by forwarding first job 116 as part of first processed jobs 140 to first external system 108.

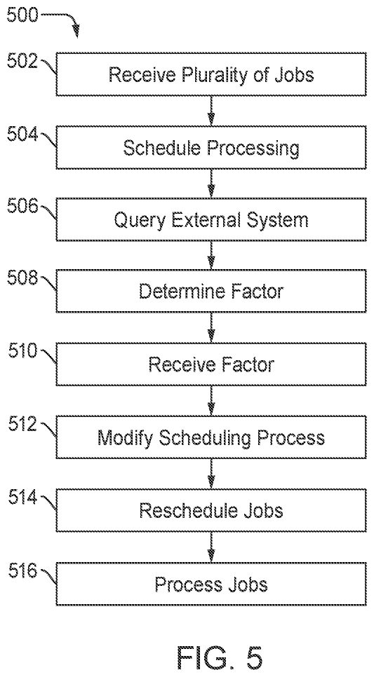

FIG. 5 depicts a flowchart 500 for managing a plurality of jobs at processing device 104 according to the disclosed embodiments. Flowchart 500 may refer to FIGS. 1A-4 for illustrative purposes. Flowchart 500, however, is not limited to the embodiments disclosed by FIGS. 1A-4.

Step 502 executes by receiving a plurality of jobs at processing device 104. For example, processing device 104 may receive first job 116 and second job 118. Step 504 executes by scheduling processing of the plurality of jobs according to schedule 308. Scheduling process 302 may generate schedule 308 for the plurality of jobs according to one or more scheduling algorithms, as disclosed above. For example, first job 116 may be placed ahead of second job 118 in job queue 114 based on scheduling process 302.

Step 506 executes by querying one or more external systems, such as first external system 108 or second external system 110. Step 506 may execute as step 406, disclosed above. Step 508 executes by determining first factor 124 or second factor 128. Step 508 may execute as step 408 disclosed above. Step 510 executes by receiving first factor 124 or second factor 128. Step 510 may execute as step 410 disclosed above. Step 512 executes by modifying scheduling process 302 in view of the received factor or factors. Step 512 may execute as step 412 disclosed above.

Step 514 executes by rescheduling first job 116 and second job 118 according to scheduling process 302, as modified by first factor 124 or second factor 128. Because of some issue or situation at first external system 108, for example, first job 116 may be placed behind second job 118 in schedule 308. First job 116 may be moved accordingly in job queue 114. Step 516 executes by processing second job 118 then first job 116 according to schedule 308.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing a workflow of a computing system, the method comprising:
receiving a job at a processing device within the computer system;
placing the job in a scheduler at the processing device;
scheduling the job to be processed according a schedule determined by a scheduling process;
querying an external system for a factor related to the external system;
modifying the scheduling process of the scheduler with the factor, wherein the job is rescheduled within the schedule; and
processing the job at the processing device according to the schedule.

2. The method of claim 1, further comprising receiving the job from a client device within the computing system.

3. The method of claim 1, wherein the processing device is a printing device.

4. The method of claim 1, wherein the scheduling process is a first in, first out (FIFO) process.

5. The method of claim 1, wherein the scheduling process is based upon a priority of the job.

6. The method of claim 1, wherein the factor includes a quality of service factor of the external system.

7. The method of claim 1, wherein the factor includes a response time by the external system.

8. The method of claim 1, wherein the factor includes a date or time of day.

9. The method of claim 1, wherein the factor includes a capacity of service.

10. A method for managing jobs within a computing system, the method comprising:
receiving a plurality of jobs at a processing device within the computer system, wherein the plurality of jobs includes a first job and a second job;
placing the plurality of jobs in a scheduler at the processing device;
scheduling the plurality of jobs to be processed according a schedule determined by a scheduling process, wherein the first job is scheduled to be processed prior to the second job;
querying an external system for a factor related to the external system;
modifying the scheduling process of the scheduler with the factor, wherein the first job is rescheduled within the schedule to be processed after the second job; and
processing the first job and the second job at the processing device according to the schedule.

11. The method of claim 10, wherein the processing device is a printing device.

12. The method of claim 11, wherein the printing device includes a digital front end (DFE).

13. The method of claim 12, wherein the scheduler is within the DFE.

14. The method of claim 10, further comprising receiving the plurality of jobs from a client device within the computing system.

15. The method of claim 10, further comprising receiving the first job from a first client device within the computing system and the second job from a second client device within the computing system.

16. The method of claim 10, wherein the factor includes a quality of service factor of the external system.

17. A computing system configured to
receive a job at a processing device within the computer system;
place the job in a scheduler at the processing device;
schedule the job to be processed according a schedule determined by a scheduling process;
query an external system for a factor related to the external system;
modify the scheduling process of the scheduler with the factor, wherein the job is rescheduled within the schedule; and
process the job at the processing device according to the schedule.

18. The computing system of claim 17, wherein the processing device is a printing device.

19. The computing system of claim 17, further configured to receive the job from a client device within the computing system.

20. The computing system of claim 18, wherein the scheduler is within a digital front end (DFE) of the printing device.
